(19) United States
(12) Patent Application Publication
(10) Pub. No.: US 2007/0018485 A1
(43) Pub. Date: Jan. 25, 2007

(54) Vehicle with sun-screen panels

(76) Inventor: Jeff A. Jacobson, Corona del Mar, CA (US)

Correspondence Address: GREENBERG TRAURIG LLP, 2450 COLORADO AVENUE, SUITE 400E, SANTA MONICA, CA, 90404, US

(21) Appl. No.: 11/187,750

(22) Filed: Jul. 22, 2005

(51) Int. Cl. B60J 7/00

(52) U.S. Cl. 296/210

(57) ABSTRACT

A vehicle having one or more panels of a silk-screened fabric material wherein the passengers in the vehicle can see out but passersby cannot easily see in allowing a private environment to the passengers. Such panels may include the roof, sides and rear of the vehicle and may be fixed or retractable by means of spring mounted rods, or motorized.

### BACKGROUND OF THE DISCLOSURE

1. Field of the Disclosure

The disclosure relates to vehicle parts and accessories; and, more particularly, to sun screened panels on a vehicle, such as a jeep or any similar vehicle.

2. Related Art

Certain types of vehicles lend themselves to accessorizing and customizing. For example, jeeps and similar vehicles having roll bars or the like are quite popular and many jeep owners replace the existing top with a more colorful or distinctive top. Also, the area behind the driver's seat is usually open and wind, sun, ultraviolet rays, etc., are problems.

### SUMMARY OF THE DISCLOSURE

There is a need for paneling for a vehicle, such as a jeep, which is unique and colorful.

It is a further object of this disclosure to provide such paneling wherein one inside the vehicle can see out through the panels but viewers outside the vehicle cannot easily see in.

It is another object of this invention to provide an environment in the vehicle of privacy, shade, blocked ultraviolet rays, and a cooler temperature in the sun.

It is still further an object of this disclosure to provide such unique and colorful paneling on various parts of the vehicle, such as side flaps, wind screens, etc.

These and other objects are preferable accomplished by providing a panel for a jeep or the like which is of a fabric material, such as nylon, silk-screened on the outside so that a colorful or patterned image appears to a viewer outside of the vehicle. Such material can also be clear or transparent or black and white. Occupants of the vehicle can see out through the material and wind from the exterior of the vehicle goes right through the material. Passersby cannot easily see inside the vehicle. Such material can also be used as a wind breaker attached to the rear uprights of the sport bar of the vehicle. Tops made with such screened material not only dissolve and block harmful ultraviolet rays, but also keep the environment in the vehicle shady and cool on a hot day and will not baffle like solid tops.

### BRIEF DESCRIPTION OF THE DRAWINGS

FIG. 1 is a perspective view of a portion of a vehicle, such as a jeep, in accordance with the teachings of the disclosure;

FIG. 2 is a view similar to FIG. 1 showing other panels in accordance with the teachings of the disclosure disposed on the vehicle of FIG. 1;

FIG. 3 is a view similar to FIG. 1 showing a vertical wind-stopper panel rearwardly of the front compartment of the vehicle of FIG. 1;

FIG. 4 is a view similar to FIG. 1 showing a full top paneling on the vehicle of FIG. 1;

FIG. 5 is a view similar to FIG. 3 showing side front panels;

FIG. 6 is a view similar to FIG. 4 showing a rear panel;

FIG. 7 is a rear view of panel 37 of FIG. 3 showing how the panel may be pulled down and retractably mounted on the vehicle;

FIG. 8 is a side view of the jeep of FIG. 1 showing a spring rod for retracting the top roof panel from front to rear thereof;

FIG. 9 is a view similar to FIG. 7 showing an alternate securement of the panel which pulls upwardly;

FIG. 10 is a view similar to FIG. 8 showing an alternate securement of the full top roof panel from rear to front thereof;

FIGS. 11 and 12 are views similar to the front side panel portion of the vehicle of FIG. 5 showing alternate fastening means thereof retractably mounted from both top to bottom and bottom to top;

FIGS. 13 and 14 are views similar to FIG. 6 showing alternate means for securing the integral full top and rear panel;

FIG. 15 is a view similar to FIG. 5 showing an alternate pleated top roof panel;

FIG. 16 is an elevational view of a removable hook element that may be use don the vehicle of FIGS. 1 to 15;

FIG. 17 is an alternate view of a portion of a panel that can be used in the vehicle of FIGS. 1 to 15 showing connectors for connecting to the hook elements of FIG. 16;

FIG. 18 is another modification for monitoring the top roof panels of FIGS. 1 to 15 to the bars 13, 14;

FIG. 19 is a view similar to FIG. 5 showing another type of roof and side material that may be a solid fabric that can be used in the invention, particularly in the retractable versions shown in FIGS. 14 and 15; and

FIG. 20 is a view similar to FIG. 18, showing another modification of the invention.

### DETAILED DESCRIPTION OF THE PREFERRED EMBODIMENTS

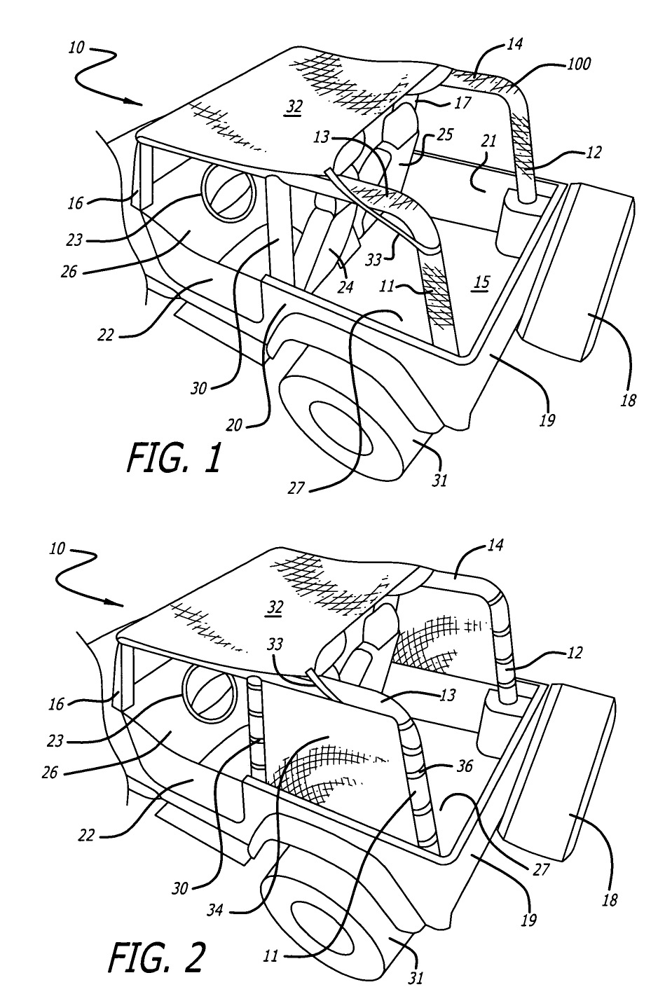

Referring now to FIG. 1 of the drawing, a portion of a vehicle, such as a jeep 10 is shown having a pair of spaced upright support bars 11, 12, extending upwardly from the floor 15 of vehicle 10 and integral with a pair of elongated generally horizontally extending roll bars 13, 14, respectively. A pair of spaced side supports 30, 17 may be integrally connected to roll bars 13, 14, respectively, as shown.

Roll bars 13, 14 extend to the front of jeep 10 and may be supported at front by a pair of spaced supports 16 (only support 16 connected to roll bar 13 on the left front of vehicle 10 is shown; a second identical support—not shown—is disposed on the right front of jeep 10 connected to roll bar 14).

Jeep 10 may include front and rear wheels (only rear wheel 31 visible in FIG. 1), a spare tire 18, upright back panel 19, interconnected spaced upright rear side panels 20, 21 and upright front side panels 22 (only the left front panel visible in FIG. 1) along with a steering wheel 23 and front seats 24, 25. Thus, jeep 10 is divided into a front driver's compartment 26 and a rear passenger or storage compartment 27.

As particularly contemplated in the present disclosure, a top panel 32 is mounted between the forward portions of roll bars 13, 14 as shown. Panel 32 is preferably of a fabric material that can allow air to pass through and is plain silk-screened on the exterior. Such materials are usually fine mesh materials of nylon or the like. The disclosure contemplates using such material to replace the pre-existing top or roof of a jeep or the like. Top 32 as shown in FIG. 4—to be discussed—may be secured to roll bars 13, 14 in any suitable manner, such as single release straps 33, mating straps of hook and loop material, inserted in tracks, tongue and groove connecting in a sliding arrangement, etc.

As seen in FIG. 2, where like numerals refer to like parts of FIG. 1, side panels 34, 35 may be provided, similar to the material of top 32, and secured to supports 11, 12, 30, 17 and roll bars 13, 14 as shown and again secured in quick release position in any suitable manner, as by straps 36 or retractable, as heretofore discussed.

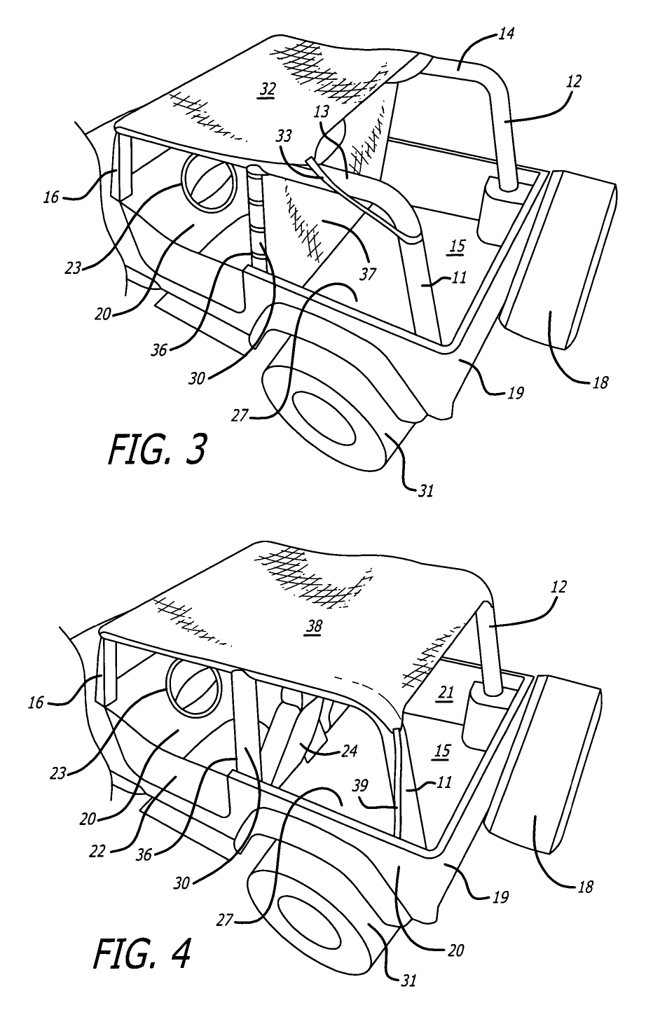

As seen in FIG. 3, wherever like numerals refer to like parts of FIGS. 1 and 2, a baffle panel 37, of fabric material similar to that of panels 32, 34 and 35, is disposed rearwardly of front compartment 26 separating the same from rear compartment 27. Again, baffle panel 37 is releasably secured to upright supports 30, 17 and roll bars 13, 14 in any suitable manner, such as quick release straps 36.

As seen in FIG. 4, the aforementioned full top panel 38 is shown releasably secured to roll bars 13, 14 in any suitable manner, such as the straps 39. Again, panel 38 is made of material similar to panel 32.

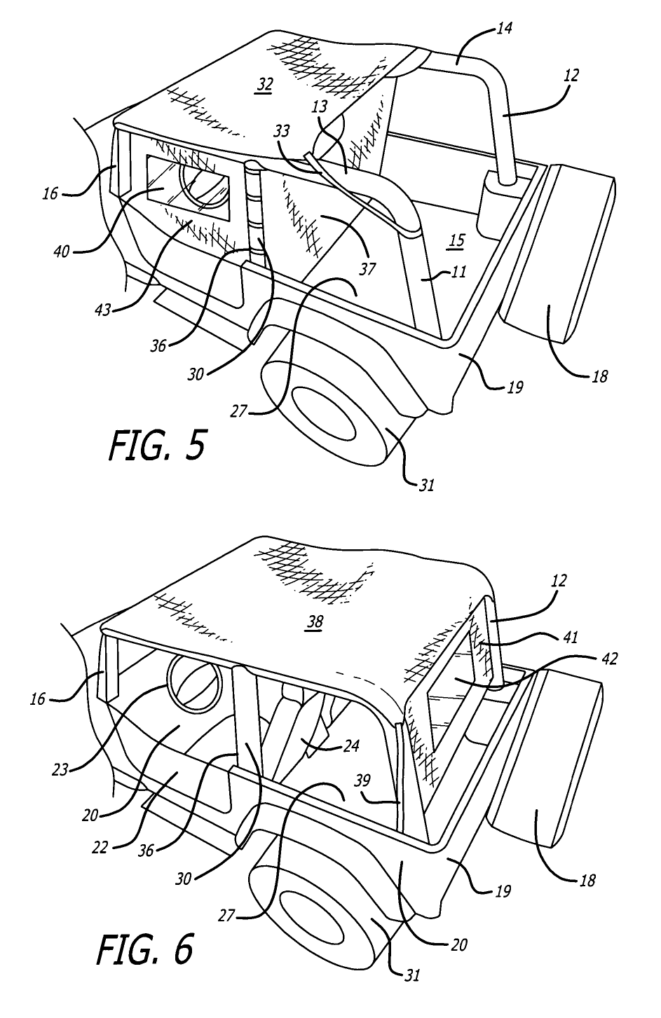

Referring to FIG. 5, where again like numerals refer to like parts of the embodiment of FIG. 3, side front panels 43 (only the left panel visible in FIG. 5) may be provided having fabric material in accordance with the disclosure with a central clear plastic window 40.

Referring to FIG. 6, wherein again like numerals refer to like parts of the embodiment of FIG. 4, a rear panel 41 of fabric material having a transparent plastic window 42, may be provided in accordance with the disclosure, held in position between upright supports 11, 12 in any suitable manner.

In the embodiments of FIGS. 5 and 6, side panels 43 and rear panel 41 may be an integral part of roof panel 32. Also, side panels 34, 35 may also be integral with top panel 32.

Thus, such material can be used for side panels or a wind screen of the jeep 10. The entire cabin of the jeep 10 may be so enclosed. The mesh material allows cool breezes to flow through while keeping the sun's heat and ultraviolet rays out. It will not flag or balloon in the breeze. Thus, to the viewer outside the vehicle, a pleasing design is presented whereas the occupants can see out but the viewers cannot see easily through the silk-screened material creating a cool environment inside jeep 10. The material is stretchable and can be used on the back of the vehicle, sides, doors, windows, or roll-bar cage, to further deflect the wind from the cool and wind-free environment inside the vehicle.

Although use on a jeep is disclosed, obviously my concept can be applied to any vehicles having removable fabric-type roofs, sides, etc., such as golf carts, convertibles, dune buggies, 4 wheel drive vehicles, ATVs, etc. Although a full or brief top of a mesh material is disclosed, such top may comprise different sections, one of said mesh material may or may not be silk-screened on the exterior and connected to a section of a differing material, such as cloth, canvas, plastic or leather.

The panels thus allow cool breezes to flow through the vehicle while keeping the sun's heat and ultraviolet rays out. The panels will not flap or balloon in the breeze. With regard to wind breaker panel 37, one size will fit all vehicles and can be used with either top 32 or 38. It reduces rear turbulence and ultraviolet rays and the material of tops 32, 28 and wind breaker 37 is durable, weather resistant and easily attached to the bars of the vehicle using quick release straps, such as those using hook and loop material. The panels may be of a black and white, black, an American flag, pirate symbol, confederate flag, or clear and transparent, camouflage design, or any other suitable design.

Panels 37, 34 and 35 may have clear transparent plastic windows therein, if desired. The sport bar cage of jeep 10 can thus have a covering panel at top, sides, rear, between the upright supports and the horizontal roll bars. The panels disclosed herein can be used on any off road vehicle, such as jeeps, and releasably secured in position using conventional straps of hook and loop material, going around the bar supports, etc.

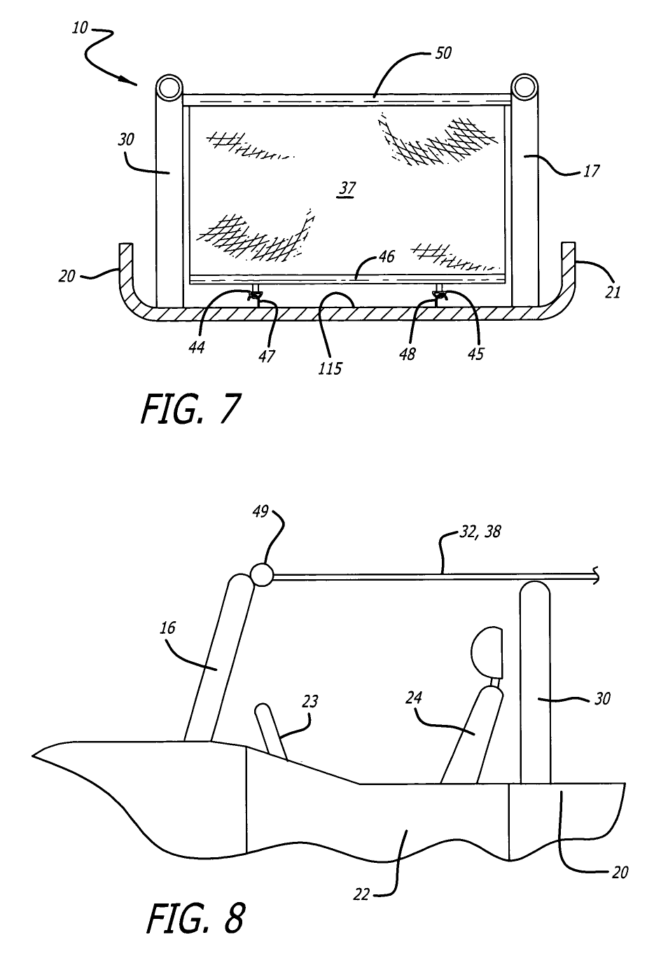

As shown in FIG. 7, where like numerals refer to like parts of the embodiment of FIG. 3, panel 37 may be retractable. That is, it may be secured at top to a spring loaded elongated bar 50, similar to a window shade bar, mounted between upright supports 30, 17 in any suitable manner, and releasably secured at bottom by spaced tie down straps 44, 45 releasably secured to the bottom rod 46 of panel 37 and to hooks 47, 48 mounted on the floor 15 of jeep 10.

Top panels 32, 38 may also be retractably mounted, as by a spring mounted rod 49 (FIG. 8) mounted between front upright supports 16 at the upper ends thereof. Both top panels 32, 38 may be so mounted and retractable, if desired.

Although separate panels are shown in FIGS. 1 to 6, obviously one or more may be mounted on jeep 10 at any one time.

The panels deflect wind and inhibit the effects of ultraviolet rays thus minimizing the harmful effects of such rays by screening and deflecting them. The panels greatly minimize wind and create an insect-proof environment. The various panels create an aesthetically pleasing interior personal space environment. The driver and passengers can see out. Passersby can not easily see what is inside the vehicle through the fabric material. Such view is minimized due to the sun screen material. Privacy is created and utilitarian benefits are achieved.

Any suitable designs or patterns, or even no design or pattern, such as clear material, may be used. The panels may be of white, red or black sun screen material. The patterns may be silk screened on the panels in any desired design and single or multicolored.

Also, as seen in FIG. 1, the roll bars 13, 14, and side supports 11, 12, may be covered with the same sun screen material, such as material 100 (only a portion of roll bar 14, 12 being shown as covered by material 100—obviously, all of the supports and roll bars may be so covered).

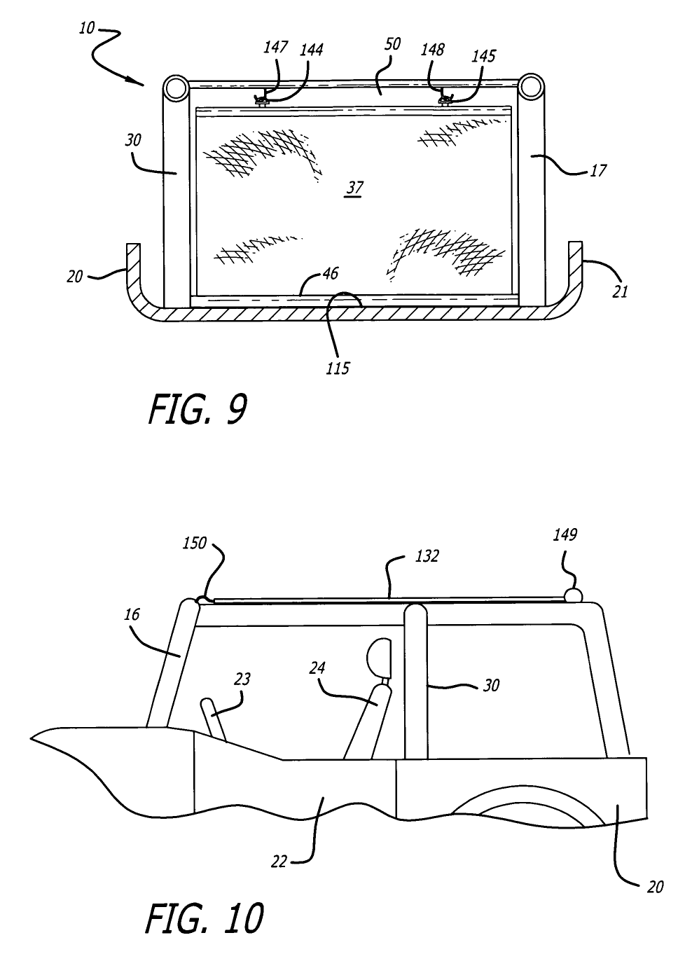

As seen in FIG. 9, wherein like numerals refer to like parts of the embodiment of FIG. 7, instead of being secured at bottom, tie down straps 144, 145 may be used to releasably secure top rod 150 to hooks 147, 148. Bottom bar 46 is secured at bottom in any suitable manner. Thus, panel 37 may be retractable either up or down.

As seen in FIG. 10, wherein like numerals refer to like parts of FIGS. 2 and 8, rod 149, similar to rod 49, is mounted rearwardly and top panel 132 can be pulled out of rod 149 and connected to hook 150 at the top of bar 16.

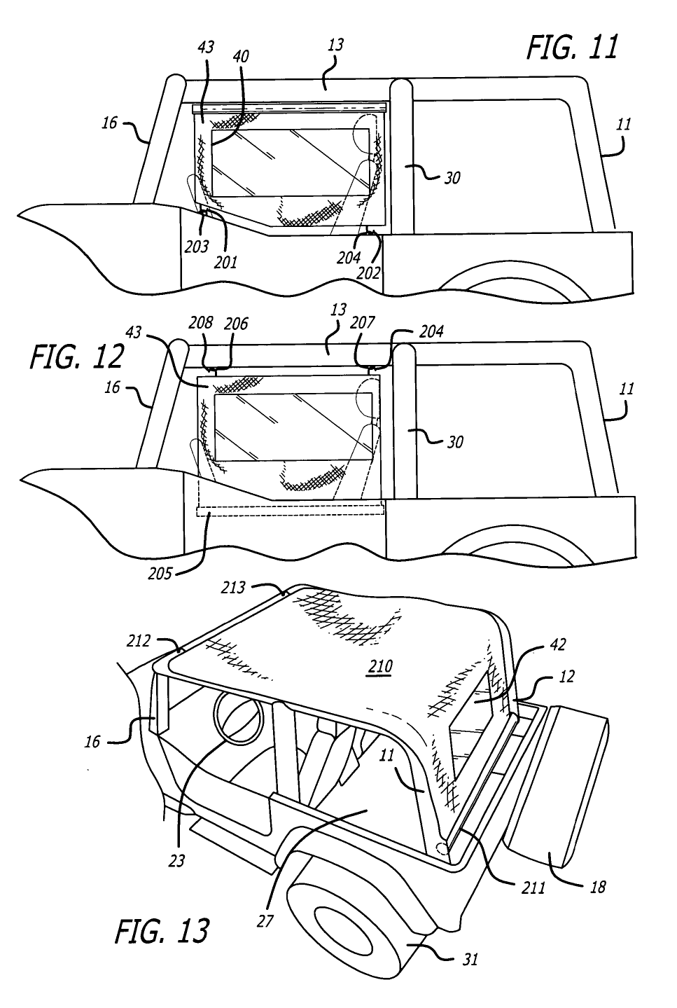

As seen in FIG. 11, wherein like numerals refer to like parts of the embodiment of FIG. 5, side panel 43 may be mounted at top to a spring rod 200 (similar to bar 50 and secured to bar 13 in any suitable manner) and pulled down to lock so that hooks 201, 202 lock to brackets 203, 204, respectively.

In FIG. 12, the side panel 43 is mounted at bottom to a spring rod 205 and releasably secured at top via hooks 206, 207 and brackets 208, 209, respectively.

In FIG. 13. wherein like numerals refer to like parts of the embodiment of FIG. 6, the top 38 and rear panel 41 of FIG. 6 are shown in FIG. 13 as one integral panel 210 extending from a spring rod 211 at bottom rear to hook and bracket assemblies 212, 213 (similar to hooks 206, 207 and brackets 208, 209) mounted at the top front of the vehicle 10.

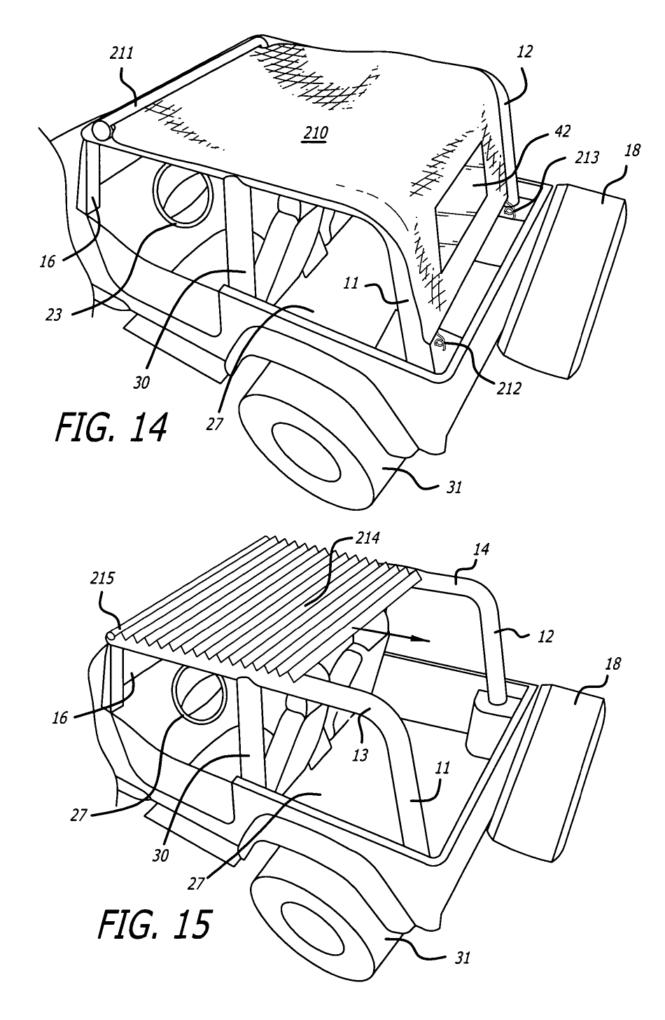

FIG. 14 is similar to the embodiment of FIG. 13 but panel 21 0 extends from spring rod 211 mounted at top front of vehicle 10 to hook and bracket assemblies 212, 213 mounted on the rear of the floor 27 of vehicle 1 0.

FIG. 15 is also similar to the embodiments of FIGS. 13 and 14 but, instead of planar panel 210, a corrugated panel 214 is shown extending rearwardly from spring rod 215, mounted at top front. Panel 214 may extend -all the way to the bottom rear if desired, and releasably secured, as by hook and bracket assemblies, as heretofore discussed. Panel 214 may also extend from a spring rod (not shown) mounted at the bottom rear of vehicle 1 0 to the top front (also not shown).

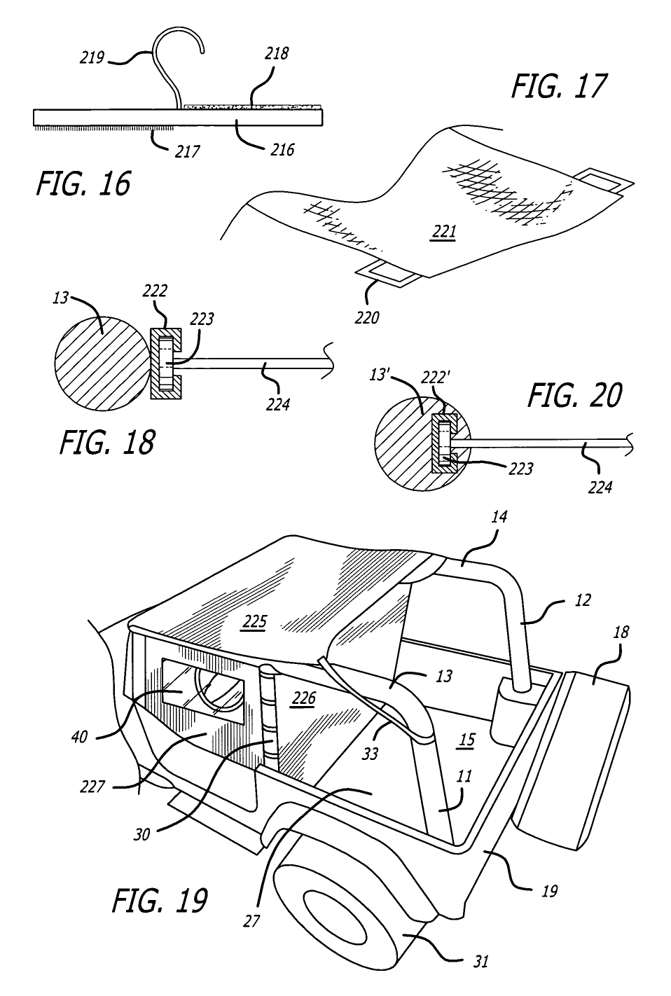

Various methods may be used to secure the various panels to the top and side bars. For example, as shown in FIG. 16, removable strips 216 may be provided having releasable hook and loop material 217, 218 so that the strips may be releasably mounted along bars 11 to 14 at suitable locations. Hooks 219 protrude from strips 216 adapted to engage V-shaped brackets 220 (FIG. 17) attached to the panels, such as panel 221, at various locations.

As discussed in the various embodiments, the top panels can be pulled forwardly and rearwardly, if desired. As seen in FIG. 18, bracket 222 may be secured to each top rail 13, 14 (only rail 13 shown) and the bracket 222 has a slotted opening receiving therein a roller 223 having a rod 224 connected thereto. Rod 224 may be secured to the aforementioned top panels, as, for example, panel 32 of FIG. 5, so it can be pulled back and forth within bracket 222.

As seen in FIG. 19, wherein like numerals refer to like parts of the embodiment of FIG. 5, top panel 225, windbreaker 226, and front side panels 227 may be of a solid material, plain or printed, and not of the silk-screened material previously described. Of course, panels 225, 226 and 227 may be secured to the vehicle 10 in the various arrangements heretofore discussed.

Finally, as seen in FIG. 20, track 222 (FIG. 18) can be built into the top rails, such as T-shaped slot 222′ built into top rail 13′ receiving roller 223 thereon. Such roller 223, and rollers 223 in FIG. 18, can be moved within slots 222 and 222′ by either motorized means or a spring rod, as rod 49 in FIG. 8. In all embodiments, rods 224 may be sewn or heat-sealed to the fabric material.

Although a particular embodiment of the disclosure is disclosed, variations thereof may occur to an artisan and the scope of the disclosure should only be limited by the scope of the appended claims.

1. A vehicle having a chassis mounted on wheels, and at least a front driver's compartment, said vehicle comprising:
a top roof panel comprised of a piece of fabric material having a mesh allowing wind to pass therethrough, said piece of fabric material being silk-screened on the outside thereof whereby a viewer outside of the vehicle sees the silk-screened exterior but cannot easily see through the piece of fabric material into the interior of the vehicle.

2. The vehicle of claim 1 wherein said vehicle is a jeep.

3. The vehicle of claim 2 wherein said piece of material comprises one half of the top of the vehicle, overlying the driver's compartment.

4. The vehicle of claim 1 wherein vehicle has a passenger's compartment rearwardly of said diver's compartment and said top roof panel overlies both compartments.

5. The vehicle of claim 1 wherein said material is of nylon or other synthetic material.

6. The vehicle of claim 1 wherein said vehicle includes spaced upright posts and roll bars connected at top to said posts, such top roof panel being releasably connected to said roll bars.

7. The vehicle of claim 1 wherein a windscreen panel is provided on said vehicle, said windscreen panel being comprised of said mesh material silk-screened on the exterior thereof, said vehicle having a rear passenger compartment and said windscreen panel being disposed between said front driver's compartment and said rear passenger compartment.

8. The vehicle of claim 7 wherein said windscreen panel is retractably mounted on said vehicle.

9. The vehicle of claim 1 wherein said silk-screened piece of fabric material includes a pictorial design.

10. The vehicle of claim 1 wherein said vehicle is a jeep having roll bars, said roll bars being covered with a fabric mesh material silk-screened on the exterior thereof.

11. The vehicle of claim 1 wherein said top roof panel is retractably mounted on said vehicle.

12. The vehicle of claim 11 wherein said top roof panel is retractable from the front to a point along the top of said vehicle.

13. The vehicle of claim 11 wherein said vehicle has a rear and a bottom floor and is retractable from the front to the rear of said vehicle adjacent the bottom floor thereof.

14. The vehicle of claim 1 including rear side walls of said fabric material mounted to spaced upright posts on said vehicle.

15. The vehicle of claim 14 including transparent viewing windows mounted in said rear side walls.

16. The vehicle of claim 1 including front side walls of said fabric material mounted to spaced upright posts on said vehicle.

17. The vehicle of claim 16 wherein said front side walls are retractable to move up and down.

18. The vehicle of claim 16 including transparent viewing windows mounted in said front side walls.

19. The vehicle of claim 1 including a rear panel of said fabric material mounted between spaced upright supports on said vehicle.

20. The vehicle of claim 19 including a transparent viewing window mounted in said rear panel.

21. The vehicle of claim 1 wherein said roof panel is releasably attached to roll bars mounted on said vehicle at a plurality of locations along said roll bars.

22. The vehicle of claim 1 wherein said vehicle includes a plurality of spaced roll bars mounted on said vehicle, said roof panel being movable along rollers disposed in brackets mounted to said roll bars.

23. A vehicle having at least a top and sides, and a front seat in a driver's compartment comprising:
a piece of fabric material disposed as a windbreaker panel between the rear of the front seat and the rear of the vehicle, having a mesh allowing wind to pass therethrough, said piece of fabric material being silk-screened on the outside thereof whereby a viewer outside of the vehicle sees the silk-screened exterior but cannot see through the piece of fabric material into the front seat of the vehicle.

24. The vehicle of claim 23 wherein said vehicle is a jeep.

25. The vehicle of claim 24 wherein said jeep has a sport bar rearwardly of the front seat and said windbreaker panel is fixed to said sport bar.

26. The vehicle of claim 23 wherein said material is of nylon.

27. The vehicle of claim 23 wherein said silk-screened piece of fabric material includes a pictorial design.

28. The vehicle of claim 23 wherein a top roof panel of said material extends over the driver's compartment.

29. The vehicle of claim 23 including a passenger compartment rearwardly of said driver's compartment, said windbreaker panel being disposed between said compartments, and a top roof panel of said material extending over both compartments.

30. A vehicle having a chassis mounted on wheels, and at least a front driver's compartment, said vehicle comprising:
a top roof panel comprised of a piece of solid flexible material, a windbreaker of solid flexible material extending from said top roof panel downwardly behind said front compartment, and a pair of spaced front side panels of solid flexible material extending downwardly from said top roof panel on opposite sides of said front compartment.

31. The vehicle of claim 30 wherein said top roof panel is retractably mounted.

32. The vehicle of claim 31 wherein said vehicle has top spaced roll bars and said top roof panel is retractably mounted by means of a spring mounted rod connected thereto movable along said spaced roll bars.

33. The vehicle of claim 31 wherein said vehicle has top spaced rollers and said top roof panel is retractably mounted by motorized means associated with said top roof panel and said spaced rollers.
